(19) United States
(12) Patent Application Publication
(10) Pub. No.: US 2020/0383479 A1
(43) Pub. Date: Dec. 10, 2020

(54) SLIDING, PIVOTING AND RECLINER SITTING MECHANISM FOR CHAIR AND BENCH

(71) Applicant: Nabile LALAOUA, Las Vegas, NV (US)

(72) Inventor: Nabile LALAOUA, Las Vegas, NV (US)

(21) Appl. No.: 16/763,576

(22) PCT Filed: Mar. 1, 2019
(86) PCT No.: PCT/IB2019/051686

§ 371 Date: May 13, 2020

Related U.S. Application Data
(60) Provisional application No. 62/710,826, filed on Mar. 1, 2018.

(51) Int. Cl. A47C 1/032; A47C 7/70; A47C 7/00; A47C 7/72; A47C 11/00; B60B 33/00; A47C 3/40; A47C 7/62; A47G 9/02; H02J 7/00; A61H 7/00

(52) U.S. Cl. CPC A47C 1/03294; A47C 7/705; A47C 7/006; A47C 7/725; A47C 7/727; A47C 11/005; A47C 4/28; A47C 3/40; A47C 7/624; A47C 7/626; A47G 9/0223; H02J 7/0042; A61H 7/00; B60B 33/0094

(57) ABSTRACT

A sliding, pivoting and recliner sitting mechanism for chair and bench enables a seated user to transition between an upright position and a reclined position. To accomplish this the sitting mechanism has a seat platform, a back frame, a cushion, a backrest, and an adjustable leg assembly. Seat platform and the backrest are connected to form an L-shaped frame. The backrest is pivotably connected in between the back frame and the cushion so that angular displacement of the backrest can be used to linearly displace the cushion along the seat platform. The adjustable leg assembly is mounted beneath the seat platform and enables the user to modify the height of the cushion. Accordingly, the sitting mechanism can be used by individuals of varying shape and size.

### FIELD OF THE INVENTION

The present invention relates generally to a chair. More specifically, the present invention relates to a chair with an integrated reclining mechanism.

### BACKGROUND OF THE INVENTION

Traditional chairs serve a specific function. These devices can range from utilitarian affairs to luxury offerings. While there are chairs that perform a plurality of functions performed by traditional chairs, there are various health and wellness benefits that can be achieved by integrating adjustable mechanisms into the chair frame.

The present invention increases the health benefits offered by a chair by incorporating a tilting mechanism into the chair frame. Specifically, the present invention is a dining chair with a sliding seat and a reclining backrest mechanism. The backrest can be mounted between an L-shaped frame and a cushion to create a tilting and reclining mechanism. This enables the user to maintain their back in an orientation that improves posture, circulation, and overall health and wellness. Additionally, the present invention is designed to offer functional benefits such as vibration, electrical device charging, and personal item storage.

### BRIEF DESCRIPTION OF THE DRAWINGS

FIG. 1 is a perspective view of the present invention in an upright configuration.

FIG. 2 is a perspective view of the present invention in a reclined configuration.

FIG. 3 is a front view of the present invention.

FIG. 4 is a rear view of the present invention.

FIG. 5 is a right-side view of the present invention in an upright configuration.

FIG. 6 is a right-side view of the present invention in an upright configuration.

FIG. 7 is a left-side view of the present invention in an upright configuration.

FIG. 8 is a top view of the present invention showing the blanket.

FIG. 9 is a bottom view of the present invention.

FIG. 10 is a block diagram showing the electrical connections between the components of the present invention.

FIG. 11 is perspective view of an alternative embodiment of present invention being used as a bench with multiple seats.

### DETAIL DESCRIPTIONS OF THE INVENTION

All illustrations of the drawings are for the purpose of describing selected versions of the present invention and are not intended to limit the scope of the present invention.

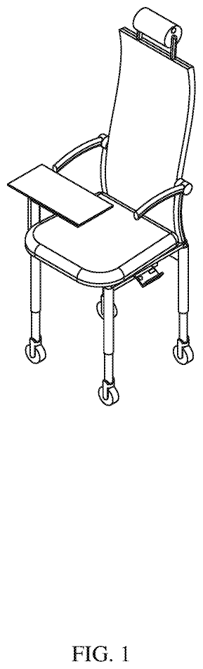

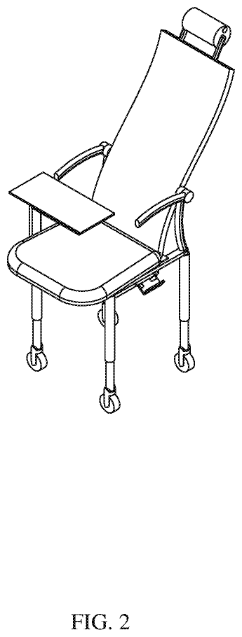

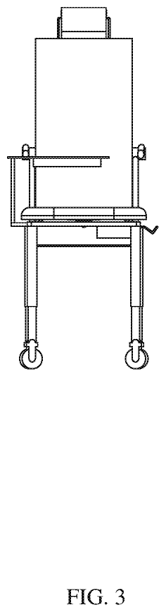

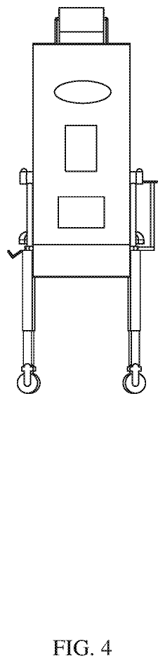

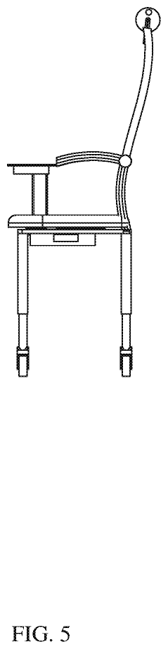

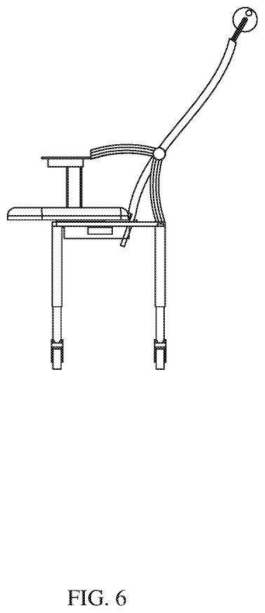

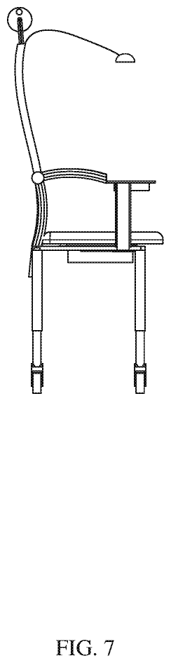

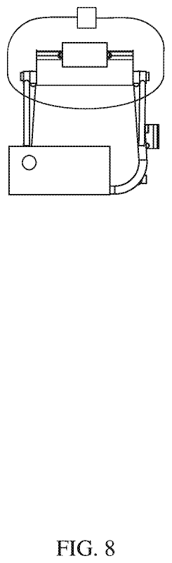

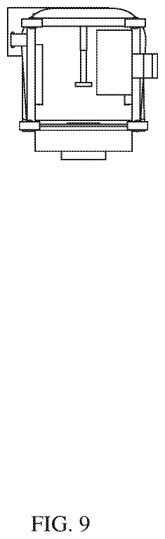

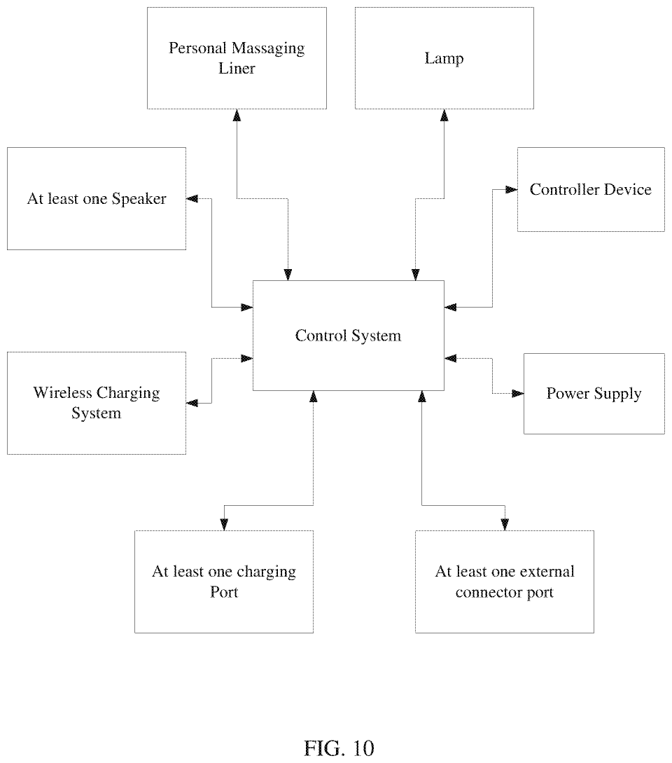

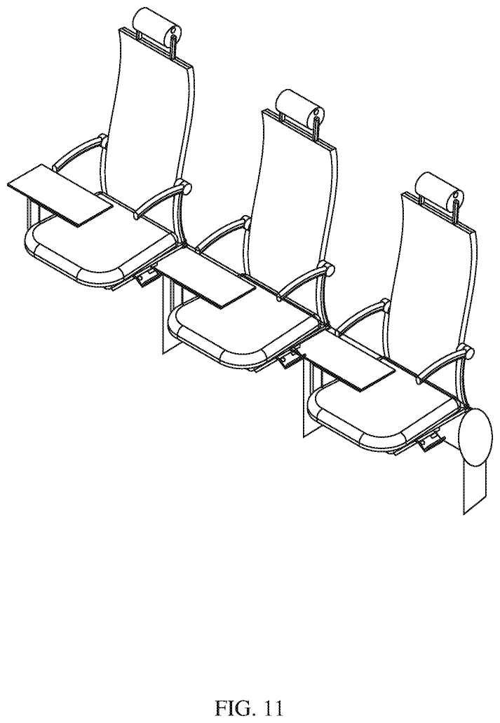

Referring to FIG. 1 through FIG. 11, the preferred embodiment of the present invention, the sliding, pivoting and recliner sitting mechanism for chair and bench is a seat system that enables a seated user to recline while maintaining a healthy posture. To achieve this functionality, the present invention comprises a seat platform, a back frame, a position modification system, a cushion, a backrest, and an adjustable leg assembly. The back frame is mounted onto the seat platform and angularly offset from a first face of the seat platform. Thus positioned, the back frame and the seat platform form a structure that supports the weight of the user. Additionally, the seat platform and the back frame are configured to facilitate transitioning the present invention between a reclined configuration and an upright configuration. While in the upright configuration, the present invention maintains the user's back in an orientation that is sufficiently perpendicular to the first face of the seat platform. While in the reclined configuration, the present invention maintains the user's back in an orientation that angularly offset from the first face of the seat platform by an obtuse angle. The position modification system is a linkage assembly that enables the cushion to form a reconfigurable connection with the seat platform. Specifically, the position modification system is operatively coupled in between the cushion and the seat platform, wherein the position modification system enables the cushion to move across the first face of the seat platform. Thus connected, the position modification system enables the cushion to be displaced across the first face of the seat platform while remaining tethered to the seat platform. In some embodiments the position modification system enables the cushion to be pivotably coupled to the seat platform such that the cushion can be angularly displaced ad well as linearly displaced, relative to the first face of the seat platform.

To further facilitate the transition between the upright configuration and the reclined configuration, the cushion is pivotably connected to the back rest. Additionally, the backrest is pivotably connected to the hack frame. Further, the pivotable connection between the backrest and the back frame is positioned offset from the pivotably connection between the cushion and the backrest. As a result, the backrest acts as a lever that pivots about the back frame when the user transitions the present invention between the upright configuration and the reclined configuration. because the backrest and the cushion are pivotably connected, angular displacement of the backrest is translated into linear displacement of the cushion along the first face of the seat platform. The adjustable leg assembly is a support structure that enables the seat platform to be linearly displaced such that the present invention can be adapted to be used by individuals of varying height. To that end, the adjustable leg assembly is mounted adjacent to a second face of the seat platform. The second face is positioned opposite to the first face, across the seat platform. Accordingly, the adjustable leg assembly is positioned between the seat platform and a surface on which the present invention rests. Preferably, the adjustable leg assembly and the back frame are pivotably coupled to the seat platforms so that the present invention functions as a folding chair that can be collapsed while not in use. In an alternative embodiment the present invention is configured to form a bench with a plurality of sliding, pivoting and recliner seats. In this embodiment a plurality of users is able to sit on the present invention. Additionally, each of the plurality of users is able to transition a corresponding seat between the upright configuration and the reclined configuration, as desired. The accessory-charging tray is a storage system for personal items including, but not limited to, cellphones, tablet computers, and portable music players. The accessory-charging tray is designed to wirelessly charge the personal item while the personal item is resting on the accessory-charging tray. The accessory-charging tray being mounted adjacent to the second face. Accordingly, the accessory-charging tray is positioned to facilitate storage and retrieval of the personal item.

As described above, the seat platform is a rigid frame that supports the weight of the user. To achieve this functionality, the seat platform comprises at least one first sidebar, at least one second sidebar, and at least one crossbar. Additionally, the crossbar is connected in between the first sidebar and the second sidebar. As a result, the crossbar maintains the first sidebar and the second side bar in positions that facilitate evenly distributing the weight of the user.

Preferably the cushion is linearly displaced across the seat platform when transitioning between the upright configuration and the reclined configuration. To facilitate this, the position modification system comprises a resistance member and at least one slide rail. The resistance member is a device that resists the linear displacement of the cushion. Preferably, the resistance member is a passive system that returns the present invention to the upright configuration when no external forces are applied to the backrest or cushion. The term “resistance member” is used herein to refer to devices including, but not limited to, springs, elastic, hands, and pressurized systems. The resistance member being connected in between the first crossbar and the cushion. Accordingly, the resistance member exerts sufficient force to moderate the movement of the cushion. In an alternative embodiment, the resistance member is replaced with an actuator. The actuator enables the user to automatically transition the present invention between the upright configuration and the reclined configuration. The slide rail is mounted in between the first sidebar and the second sidebar. Additionally, the slide rail is oriented parallel to the first sidebar and the second sidebar. Further, the cushion is slidably mounted onto the slide rail. As a result, the slide rail forms a track along which the cushion travels when the present invention is transitioned between the upright configuration and the reclined configuration.

The back frame is designed to enable the backrest to pivot under the application of an external force. To achieve this functionality, the back frame comprises a first support arm, a second support arm, a first pivoting coupler, and a second pivoting coupler. The first face of the seat platform is terminally connected to the first support arm. Similarly, the first face of the seat platform is terminally connected to the second support arm. Additionally, the second support arm being positioned offset from the first support arm, across the seat platform. As a result, the first support arm and the second support arm form a frame capable of supporting the weight of the user while maintaining the back rest in a desired orientation. The backrest being pivotably connected in between the first support arm and the second support arm. More specifically, the first pivoting coupler is terminally connected to the first support arm, opposite to the seat platform. Additionally, the second pivoting coupler is terminally connected to the second support arm, opposite to the seat platform. Further, the backrest is connected in between the first pivoting coupler and the second pivoting coupler. As a result, the backrest is able to rotate about an axis formed between the first pivoting coupler and the second pivoting coupler. Preferably, the back rest further comprises a bracing bar. The bracing bar is connected in between the first support arm and the second support arm. Additionally, the bracing bar is connected adjacent to the seat platform. As a result, the bracing bar forms a backstop that limits the travel of the backrest and the cushion when transitioning from the reclined configuration into the upright configuration.

The present invention is designed to function as an ergonomic device that is used to improve the user's health and posture. To that end, the present invention further comprises, a first armrest, a second armrest, and an adjustable head-and-neck rest. The first armrest is pivotably connected to the back frame. Additionally, the second armrest is pivotably connected to the back frame, opposite to the first arm rest. As a result, the first armrest and the second armrest can be repositioned to support the user's arms while the present invention is in both the upright configuration and the reclined configuration. Additionally, the pivotable connections for the first armrest and the second armrest enable the two components to be pivoted out of the way for storage. Additionally, the first armrest and the second armrest can be locked into a desired position and then unlocked by the user. The adjustable head-and-neck rest is terminally mounted onto the backrest, opposite to the cushion. As a result, the adjustable head-and-neck rest can be repositioned to support the head and neck of users of varying height. Further, the adjustable head-and-neck rest, the first armrest, and the second armrest are designed to facilitate maintaining the user's back in an orientation that promotes health and wellness. In the preferred embodiment, the present invention comprises a first pocket and a second pocket. The first pocket is mounted onto a rear face of the back rest. Additionally, the second pocket is mounted onto the rear face of the back rest. Further, the second pocket being oriented perpendicular to the first pocket. As a result, the first pocket and the second pocket can be easily accessed when the user is seated or standing.

In addition to therapeutic benefits, the present invention is designed to be a functional device that improves the user's quality of life. To that end, the present invention, comprises at least one speaker, at least one adjustable lamp, a personal massaging liner, and a controller device. The speaker is integrated into the adjustable head-and-neck rest. As a result, the speaker is able to produce sounds and music that soothes or entertains the user. Preferably, the adjustable lamp is a lighting device that is maintained in a desired orientation be an adjustable support arm. The adjustable lamp is mounted onto the backrest and positioned adjacent to the adjustable head-and-neck rest. Consequently, the adjustable lamp can be used to light the area around the user while performing activities, such as reading. The adjustable support arm may be a gooseneck device that enables the user to reposition the light source as desired. The personal massaging liner is an electronic device that massages the user. The personal massaging liner is superimposed onto a front face of the backrest, a front face of the cushion, and laterally mounted onto the head-and-neck rest. As a result, the personal massaging liner is able to massage the user's back, neck, and head. Preferably the personal massaging liner has a temperature control system that enables the user to heat or cool the present invention. Thus, adding therapeutic benefits to a traditional massage.

The accessory-charging tray expands on the functional aspects of the present invention. To accomplish this, the accessory-charging tray comprises a tray body, at least one power supply, at least one wireless charging device, at least one charging port, and at least one external device connector port. The tray body is a rigid device that is ergonomically designed to hold a personal item in an orientation that facilitates wireless charging. Preferably, the accessory charging tray comprises a contoured surface that retains the personal item in an orientation that facilitates storage and retrieval. The tray body is mounted adjacent to the seat platform. As a result, the accessory-charging tray is maintained in a position that does not hinder the user from reclining comfortably. In the preferred embodiment, the power supply is mounted onto the second face of the seat platform so that the power supply does not hinder the user from sitting comfortably. In an alternative embodiment, the power supply is mounted onto the backrest. The wireless charging device is integrated into the tray body. As a result, the personal item can be wirelessly charged simply by being rested onto the tray body. The at least one charging port and the at least one external connector port are integrated into the tray body. Thus positioned, the user can physically and electrically connect the personal item to the tray body. Additionally, the wireless charging device and the charging port are electrically connected to the power supply. Accordingly, the power supply provides the electrical needs of the present invention. Preferably, the power supply is a rechargeable battery.

The present invention is designed to enable the user to connect to and participate with digital communities. To achieve this functionality, the present invention comprises a control system, a wireless communications system. The control system is a computing device capable of coordinating the activities of the electrical systems of the present invention. The control system and the wireless communications system are adjacently connected to the second face of the seat platform. As a result, the control system and the wireless communications system are maintained in a position that does not hinder the user from reclining comfortably. The control system is electronically connected to the wireless communications system and the position modification system. Additionally, the remote-controller device is communicably coupled to the wireless communications system. As a result, the controller device is able to send and receive data between these components. Additionally, the user is able to wirelessly control the operations of the present invention by inputting commands into the controller device.

The adjustable leg assembly is designed to enable the user to reposition the cushion for users of varying height. To achieve this functionality, the present invention comprises a plurality of length-adjustable legs and a plurality of lockable wheels. A first end of each of the plurality of length-adjustable legs is detachably mounted onto the seat platform. Accordingly, the adjustable leg assembly can be disconnected from the seat platform for storage or transport. Each of the plurality of lockable wheels is adjacently connected to a second end of a corresponding leg, wherein the corresponding leg is from the plurality of length-adjustable legs. Accordingly, the present invention is designed to roll across the ground while the plurality of lockable wheels is unlocked. Preferably the plurality of lockable wheels becomes locked when the user takes a seat on the cushion and then becomes unlocked when the user stands up.

As described above, the present invention is designed to be a functional device. To that end, the present invention further comprises a tabletop, an intermediary frame, a cupholder, a storage compartment, at least one drawer, a blanket, a blanket pocket, and at least one fastener. The intermediary frame is a support structure that maintains the table top in a desired position and orientation. Specifically, the intermediary frame is detachably mounted onto the seat platform and the intermediary frame is connected in between the seat platform and the tabletop. As a result, the tabletop is maintained in an orientation that facilitates dining and functional use. The cupholder normally traversing into the tabletop so that a cup can be held in place. The storage compartment is mounted onto the intermediary frame and connected adjacent to the tabletop. Accordingly, the user can store personal items beneath the tabletop. The drawer is slidably mounted onto the second face of the seat platform. Additionally, the drawer is positioned offset from the adjustable leg assembly, across the seat platform. Consequently, the drawer does not hinder the adjustable nature of the adjustable leg assembly. The blanket is wrapped around the backrest. Additionally, the fastener is connected in between a first end of the blanket and a second end of the blanket. As a result, the user can pull the blanket around themselves when required. Additionally. the user can store the blanket by connecting the first end to the second end. The blanket pocket is mounted onto the rear face of the backrest. So that the user can store the blanket when not in use.

Although the invention has been explained in relation to its preferred embodiment, it is to be understood that many other possible modifications and variations can be made without departing from the spirit and scope of the invention as hereinafter claimed.

What is claimed is:

1. A sliding, pivoting and recliner sitting mechanism for chair and bench comprising:
a seat platform;
a back frame;
a position modification system;
a cushion;
a backrest;
an adjustable leg assembly;
at least one accessory-charging tray;
the back frame being mounted onto the seat platform;
the back frame being angularly offset from a first face of the seat platform;
the position modification system being operatively coupled in between the cushion and the seat platform, wherein the position modification system enables the cushion to move across the first face of the seat platform;
the cushion being pivotably connected to the back rest;
the backrest being pivotably connected to the back frame;
the pivotable connection between the backrest and the back frame being positioned offset from the pivotably connection between the cushion and the backrest;
the adjustable leg assembly being mounted adjacent to a second face of the seat platform;
the second face being positioned opposite to the first face, across the seat platform;
the accessory-charging tray being mounted adjacent to the second face;

2. The sliding, pivoting and recliner sitting mechanism for chair and bench as claimed in claim 1 comprising:
the seat platform comprising at least one first sidebar, at least one second sidebar, and at least one crossbar;
the crossbar being connected in between the first sidebar and the second sidebar;

3. The sliding, pivoting and recliner sitting mechanism for chair and bench as claimed in claim 2 comprising:
the position modification system comprising a resistance member and at least one slide rail;
the resistance member being connected in between the first crossbar and the cushion;
the slide rail being mounted in between the first sidebar and the second sidebar;
the slide rail being oriented parallel to the first sidebar and the second sidebar;
the cushion being slidably mounted onto the slide rail;

4. The sliding, pivoting and recliner sitting mechanism for chair and bench as claimed in claim 2 comprising:
the position modification system comprising an actuator and at least one slide rail;
the actuator being connected in between the first crossbar and the cushion;
the slide rail being mounted in between the first crossbar and the second crossbar;
the cushion being slidably mounted onto the slide rail;

5. The sliding, pivoting and recliner sitting mechanism for chair and bench as claimed in claim 1 comprising:
the back frame comprising a first support arm and a second support arm;
the first face of the seat platform being terminally connected to the first support arm;
the first face of the seat platform being terminally connected to the second support arm;
the second support arm being positioned offset from the first support arm, across the seat platform;
the backrest being pivotably connected in between the first support arm and the second support arm;

6. The sliding, pivoting and recliner sitting mechanism for chair and bench as claimed in claim 5 comprising:
the back frame further comprising a first pivoting coupler and a second pivoting coupler;
the first pivoting coupler being terminally connected to the first support arm, opposite to the seat platform;
the second pivoting coupler being terminally connected to the second support arm, opposite to the seat platform;
the backrest being connected in between the first pivoting coupler and the second pivoting coupler;

7. The sliding, pivoting and recliner sitting mechanism for chair and bench as claimed in claim 5 comprising:
the back frame further comprising a bracing bar;
die bracing bar being connected in between the first support arm and the second support arm;
die bracing bar being connected adjacent to the seat platform;

8. The sliding, pivoting and recliner sitting mechanism for chair and bench as claimed in claim 1 comprising:
a first armrest;
a second armrest;
the first armrest being pivotably connected to the back frame;
the second armrest being pivotably connected to the hack frame, opposite to the first armrest;

9. The dinning sliding and recliner chair apparatus as claimed in claim 1 comprising:
an adjustable head-and-neck rest;
the adjustable head-and-neck rest being terminally mounted onto the backrest, opposite to the cushion;

10. The dinning sliding and recliner chair apparatus as claimed in claim 9 comprising:
at least one speaker;
at least one adjustable lamp;
the speaker being integrated into the adjustable head-and-neck rest;
the adjustable lamp being mounted onto the backrest;
the adjustable lamp being positioned adjacent to the adjustable head-and-neck rest;

11. The sliding, pivoting and recliner sitting mechanism for chair and bench as claimed in claim 9 comprising:
a personal massaging liner;
a controller device;
die personal massaging liner being superimposed onto a front face of the backrest and a front face of the cushion;
the personal massaging liner being laterally mounted onto the adjustable head-and-neck rest;
the controller device being communicably coupled to the personal massaging liner;

12. The sliding, pivoting and recliner sitting mechanism for chair and bench as claimed in claim 1 comprising:
the accessory-charging tray comprising a tray body, at least one power supply, at least one wireless charging device, and at least one charging port;
the tray body being mounted adjacent to the seat platform;
the power supply being mounted onto the second face of the seat platform;
the wireless charging device being integrated into the tray body;
the charging port being integrated into the tray body;
the wireless charging device and the charging port being electrically connected to the power supply;

13. The sliding, pivoting and recliner sitting mechanism for chair and bench as claimed in claim 11 comprising:
the accessory-charging tray further comprising at least one external connector port;
the external connector port being integrated into the tray body;
the external connector port being electrically connected to the power supply;

14. The sliding, pivoting and recliner sitting mechanism for chair and bench as claimed in claim 11, wherein the power supply is a rechargeable battery

15. The sliding, pivoting and recliner sitting mechanism for chair and bench as claimed in claim 1 comprising:
the accessory-charging tray comprising at least one power supply;
the power supply being mounted onto a rear face of the backrest;

16. The sliding, pivoting and recliner sitting mechanism for chair and bench as claimed in claim 1 comprising:
a first pocket;
a second pocket;
the first pocket being mounted onto a rear face of the back rest;
the second pocket being mounted onto the rear face of the back rest;
the second pocket being oriented perpendicular to the first pocket;

17. The sliding, pivoting and recliner sitting mechanism for chair and bench as claimed in claim 1 comprising:
a control system;
a wireless communications system;
a controller device;
the control system being adjacently connected to the second face of the seat platform;
the wireless communications system being adjacently connected to the second face of the seat platform;
the control system being electronically connected to the wireless communications system and the position modification system;
the remote-controller device being communicably coupled to the wireless communications system;

18. The sliding, pivoting and recliner sitting mechanism for chair and bench as claimed in claim 1 comprising:
the adjustable leg assembly comprising a plurality of length-adjustable legs and a plurality of lockable wheels;
a first end of each of the plurality of length-adjustable legs being detachably mounted onto the seat platform;
each of the plurality of lockable wheels being adjacently connected to a second end of a corresponding leg, wherein the corresponding leg is from the plurality of length-adjustable legs;

19. The sliding, pivoting and recliner sitting mechanism for chair and bench as claimed in claim 1 comprising:
a tabletop;
an intermediary frame;
a cup-holder;
a storage compartment;
the intermediary frame being detachably mounted onto the seat platform;
the intermediary frame being connected in between the seat platform and the tabletop;
the cupholder normally traversing into the tabletop;
the storage compartment being mounted onto the intermediary frame;
the storage compartment being connected adjacent to the tabletop;

20. The sliding, pivoting and recliner sitting mechanism for chair and bench as claimed in claim 1 comprising:
at least one drawer;
the drawer being slidably mounted onto the second face of the seat platform;
the drawer being positioned offset from the adjustable leg assembly, across the seat platform;

21. The sliding, pivoting and recliner sitting mechanism for chair and bench as claimed in claim 1 comprising:
a blanket;
at least one fastener;
die blanket being wrapped around the backrest;
the fastener being connected in between a first end of the blanket and a second end of the blanket;

22. The sliding, pivoting and recliner sitting mechanism for chair and bench as claimed in claim 1 comprising:
the back frame being pivotably mounted onto the seat platform;
the adjustably leg assembly being pivotably mounted onto the seat platform;

23. The sliding, pivoting and recliner sitting mechanism for chair and bench as claimed in claim 1, wherein the present invention is configured to form a bench with a plurality of sliding, pivoting and recliner seats.

24. The sliding, pivoting and recliner sitting mechanism for chair and bench as claimed in claim 1, wherein the cushion is pivotably mounted onto the seat platform.
